(19) United States
(12) Patent Application Publication
(10) Pub. No.: US 2004/0042632 A1
(43) Pub. Date: Mar. 4, 2004

(54) Directivity control of electro-dynamic loudspeakers

(76) Inventors: Steven W. Hutt, Bloomington, IN (US); Ronald E. Fenwick, Bloomington, IN (US); Ryan Mihelich, Indianapolis, IN (US)

Correspondence Address: HARNESS, DICKEY & PIERCE, P.L.C., P.O. BOX 828, BLOOMFIELD HILLS, MI, 48303, US

(21) Appl. No.: 10/429,162

(22) Filed: May 2, 2003

Related U.S. Application Data
(60) Provisional application No. 60/380,001, filed on May 2, 2002.
(60) Provisional application No. 60/391,134, filed on Jun. 24, 2002.
(60) Provisional application No. 60/378,188, filed on May 6, 2002.

(51) Int. Cl. H04R 1/00; H04R 9/06; H04R 11/02

(52) U.S. Cl. 381/423; 381/424

(57) ABSTRACT

This invention is an electro-dynamic loudspeaker that alters, controls and/or enhances the acoustical directivity pattern of an electro-dynamic loudspeaker through amplitude shading of the thin film diaphragm of the electro-dynamic loudspeaker and/or through the variation of the physical configuration and dimensions of the loudspeaker.

### CROSS-REFERENCE TO RELATED APPLICATIONS.

This application claims the benefit of U.S. Provisional Patent Application Serial No. 60/380,001, filed on May 2, 2002; U.S. Provisional Patent Application No. 60/378,188, filed on May 6, 2002; and U.S. Provisional Patent Application No. 60/391,134, filed on Jun. 24, 2002. The disclosures of the above applications are incorporated by reference.

This application incorporates by reference the disclosures of each of the following co-pending applications which have been filed concurrently with this application: U.S. patent application Ser. No. ______, entitled “Mounting Bracket System,” filed May 2, 2003; U.S. patent application Ser. No. ______, entitled “Film Tensioning System,” filed May 2, 2003; U.S. patent application Ser. No. ______, entitled “Film Attaching System,” filed May 2, 2003; U.S. patent application Ser. No. ______, entitled “Electrical Connectors For Electro-Dynamic Loudspeakers,” filed May 2, 2003; U.S. patent application Ser. No. ______, entitled “Electro-Dynamic Loudspeaker Mounting System,” filed May 2, 2003; U.S. patent Application Ser. No. ______, entitled “Conductors For Electro-Dynamic Loudspeakers,” filed May 2, 2003; U.S. patent application Ser. No. ______, entitled “Frame Structure,” filed May 2, 2003; U.S. patent application Ser. No. ______, entitled “Acoustically Enhanced Electro-Dynamic Loudspeakers,” filed May 2, 2003; U.S. patent application Ser. No. ______, entitled “Frequency Response Enhancements For Electro-Dynamic Loudspeakers,” filed May 2, 2003; and U.S. patent application Ser. No. ______, entitled “Magnet Arrangement For Loudspeaker,” filed May 2, 2003.

### BACKGROUND OF THE INVENTION

1. Field of Invention

This invention relates to electro-dynamic loudspeakers, and more particularly, to electro-dynamic loudspeakers that control and/or enhance the acoustical directivity pattern of the loudspeaker.

2. Related Art

The general construction of an electro-dynamic loudspeaker includes a diaphragm, in the form of a thin film, attached in tension to a frame. An electrical circuit, in the form of electrically conductive traces, is applied to the surface of the diaphragm. Magnetic sources, typically in the form of permanent magnets, are mounted adjacent to the diaphragm or within the frame, creating a magnetic field. When current is flowing in the electrical circuit, the diaphragm vibrates in response to the interaction between the current and the magnetic field. The vibration of the diaphragm produces the sound generated by the electro-dynamic loudspeaker.

Many design and manufacturing challenges present themselves in the manufacturing of electro-dynamic loudspeakers. First, the diaphragm, that is formed by a thin film, needs to be permanently attached, in tension, to the frame. Correct tension is required to optimize the resonance frequency of the diaphragm. Optimizing diaphragm resonance extends the bandwidth and reduces sound distortion of the loudspeaker.

The diaphragm is driven by the motive force created when current passes through the conductor applied to the diaphragm within the magnetic field. The conductor on the electro-dynamic loudspeaker is attached directly to the diaphragm. Because the conductor is placed directly onto the thin diaphragm, the conductor should be constructed of a material having a low mass and should also be securely attached to the film at high power (large current) and high temperatures.

Accordingly, designing conductors for electro-dynamic loudspeaker applications presents various challenges such as selecting the speaker with the desired audible output for a given location that will fit within the size and location constraints of the desired applications environment. Electro-dynamic loudspeakers exhibit a defined acoustical directivity pattern relative to each speaker's physical shape and the frequency of the audible output produced by each loudspeaker. Consequently, when an audio system is designed, loudspeakers possessing a desired directivity pattern over a given frequency range are selected to achieve the intended performance of the system. Different loudspeaker directivity patterns may be desirable for various loudspeaker applications. For example, for use in a consumer audio system for a home listening environment, a wide directivity may be preferred. In the application of a loudspeaker, a narrow directivity may be desirable to direct sound, e.g., voice, in a predetermined direction.

Often, space limitations in the listening environment prohibit the use of a loudspeaker in an audio system that possesses the preferred directivity pattern for the system's design. For example, the amount of space and the particular locations available in a listening environment for locating and/or mounting the loudspeakers of the audio system may prohibit the use of a particular loudspeaker that exhibits the intended directivity pattern. Also, due to space and location constraints, it may not be possible to position or oriented the desired loudspeaker in a manner consistent with the loudspeaker's directivity pattern. Consequently, size and space constraints of a particular environment may make it difficult to achieve the desired performance from the audio system. An example of a listening environment having such constraints is the interior passenger compartment of an automobile or other vehicle.

While the electric circuitry of electro-dynamic loudspeakers may present design challenges, electro-dynamic loudspeakers are very desirable loudspeakers because they are designed to have a very shallow depth. With this dimensional flexibility, electro-dynamic loudspeakers may be positioned at locations where conventional loudspeakers would not traditionally fit. This dimensional flexibility is particularly advantageous in automotive applications where positioning a loudspeaker at a location that a conventional loudspeaker would not otherwise fit could offer various advantages. Further, because the final loudspeaker assembly may be mounted on a vehicle, it is important that the assembly be rigid during shipping and handling so that the diaphragm or frame does not deform during installation.

While conventional electro-dynamic loudspeakers are shallow in depth and may therefore be preferred over conventional loudspeakers for use in environments requiring thin loudspeakers, electro-dynamic loudspeakers have a generally rectangular planar radiator that is generally relatively large in height and width to achieve acceptable operating wavelength sensitivity, power handling, maximum sound pressure level capability and low-frequency bandwidth. Unfortunately, the large rectangular size results in a high-frequency beam width angle or coverage that may be too narrow for its intended application. The high-frequency horizontal and vertical coverage of a rectangular planar radiator is directly related to its width and height in an inverse relationship. As such, large radiator dimensions exhibit narrow high-frequency coverage and vice versa.

The acoustical directivity of the audible output of a loudspeaker is critical to the design and performance of an audio system and to the creation of a positive acoustical interaction with the listeners in a listening environment. Because electro-dynamic loudspeaker designs are desirable for use in environments with space and location constraints, a need therefore exists to provide an electro-dynamic loudspeaker that is able to better control and/or enhance the directivity pattern of the loudspeaker.

### SUMMARY

The electro-dynamic loudspeaker of the invention controls the acoustical directivity of a loudspeaker (i.e., beam steering) by amplitude shading of the thin film diaphragm of the electro-dynamic loudspeaker or by varying the shape of the loudspeaker. Amplitude shading of the diaphragm may be achieved in a number of different ways. For example, amplitude shading may be achieved by spacing the magnets away from thin film diaphragm in specific predetermined zones of the diaphragm to reduce the sensitivity of the diaphragm.

Alternatively, amplitude shading may be accomplished by manipulating the dc resistance (DCR) of the conductor traces on the diaphragm of the loudspeaker. For example, the loudspeaker diaphragm can include a plurality of traces forming individual circuits in separate “zones” of the diaphragm. In selected zones, the traces may be in series or in parallel, electrically, in order to result in different DCR in the traces. The variable sensitivity of the traces affects the acoustical directivity of the loudspeaker by amplitude shading of the diaphragm.

In addition to the relationship of the traces electrically, the DCR of the traces may be manipulated in other ways to achieve the same effect. For example, multiple traces on the diaphragm may each possess different physical dimensions, including different lengths, different widths, different thicknesses, and cross-sectional areas. Also, the traces may be formed from different materials (including for example, copper or aluminum alloys, etc.). Such variation in physical characteristics and/or properties results in the traces having different DCR, hence, the acoustical directivity of the loudspeaker may be modified. Further, acoustical directivity control of the loudspeaker via amplitude shading may be accomplished by magnetizing the plurality of magnets in the loudspeaker so that the flux densities of the different magnets vary in a predetermined relationship relative to the diaphragm of the loudspeaker.

Similarly, the shape of the loudspeaker may also be varied to achieve a predetermined or preferred acoustical directivity performance of the loudspeaker. Manipulation of the acoustical directivity of the loudspeaker may be achieved, by varying the length-to-width aspect ratio of the planar loudspeaker, such as for example, as much as a ratio of 10:1. Such a high-aspect ratio planar loudspeaker may be suitable for installation in a structural pillar of a vehicle, such as an automobile.

Additionally, the loudspeaker may take on a non-rectangular, polygonal shape, such as a trapezoid, parallelogram, triangle, pentagon or hexagon. The shaped panel reduces off axis acoustical lobes, so that the acoustical output from the loudspeaker, particularly when amplified, provides better directional performance and control. The loudspeaker may also be configured in other shapes, including annular shapes like ellipses and circles, to obtain the desired acoustical directivity control of the loudspeaker.

In addition to varying the shape of the loudspeaker, amplitude shading of the diaphragm of the loudspeaker may be achieved by the non-uniform application of damping material over the driven zone of the diaphragm. For example, damping material may be applied in unequal and/or excessive amounts on the surface, or on selected portions of the surface, of the driven portion of the diaphragm to effectively vary the mass of the diaphragm across its surface and achieve directivity control.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a perspective view of a electro-dynamic loudspeaker as it would appear with the grille removed.

FIG. 2 is an exploded perspective view of the electro-dynamic loudspeaker shown in FIG. 1 having a grille.

FIG. 3 is a cross-sectional view of the electro-dynamic loudspeaker taken along line 3-3 of FIG. 1.

FIG. 4 is an enlarged cross-sectional view of the encircled area of FIG. 3.

FIG. 5 is a cross-sectional view taken along the line 5-5 of FIG. 1 showing an example of an electro-dynamic loudspeaker.

FIG. 6 is a cross-sectional view taken along the line 5-5 of FIG. 1 showing an alternative example of an electro-dynamic loudspeaker.

FIG. 7 is a cross-sectional view taken along the line 5-5 of FIG. 1 showing another example of an electro-dynamic loudspeaker.

FIG. 8 is schematic view showing a conductive trace on a diaphragm of an electro-dynamic loudspeaker.

FIG. 9 is a cross-sectional view taken along the line 9-9 of FIG. 8 showing the dimensional cross-section of a portion of the conductive trace.

FIG. 10 is a cross-sectional view taken along the line 10-10 of FIG. 8 showing the dimensional cross-section of the conductive trace.

FIG. 11 is a cross-sectional view taken along the line 11-11 of FIG. 8 showing the dimensional cross-section of another portion of the conductive trace.

FIG. 12 is a schematic view showing an alternative example of a conductive trace on a diaphragm of an electro-dynamic loudspeaker.

FIG. 13 is a cross-sectional view taken along the line 5-5 of FIG. 1 showing another example of an electro-dynamic loudspeaker.

FIG. 14 is a plan view of an electro-dynamic loudspeaker having a high aspect ratio of its length relative to its width.

FIG. 15 is a polar response graph depicting the natural horizontal directivity of a direct radiating electro-dynamic loudspeaker at a variety of frequencies.

FIG. 16 is a horizontal polar response plot comparing the output of an electro-dynamic loudspeaker of FIG. 14 with a conventional single tweeter loudspeaker at 1 kHz.

FIG. 17 is a horizontal polar response plot comparing the output of an electro-dynamic loudspeaker of FIG. 14 with a conventional single tweeter loudspeaker at 1.6 kHz.

FIG. 18 is a horizontal polar response plot comparing the output of an electro-dynamic loudspeaker of FIG. 14 with a conventional single tweeter loudspeaker at 3.15 kHz.

FIG. 19 is a horizontal polar response plot comparing the output of an electro-dynamic loudspeaker of FIG. 14 with a conventional single tweeter loudspeaker at 5 kHz.

FIG. 20 is a horizontal polar response plot comparing the output of an electro-dynamic loudspeaker of FIG. 14 with a conventional single tweeter loudspeaker at 8 kHz.

FIG. 21 is a horizontal polar response plot comparing the output of an electro-dynamic loudspeaker of FIG. 14 with a conventional single tweeter loudspeaker at 12.5 kHz.

FIG. 22 is a horizontal polar response plot comparing the output of an electro-dynamic loudspeaker of FIG. 14 with a conventional single tweeter loudspeaker at 16 kHz.

FIG. 23 is a vertical polar response plot comparing the output of an electro-dynamic loudspeaker of FIG. 14 with a conventional single tweeter loudspeaker at 1 kHz.

FIG. 24 is a vertical polar response plot comparing the output of an electro-dynamic loudspeaker of FIG. 14 with a conventional single tweeter loudspeaker at 1.6 kHz.

FIG. 25 is a vertical polar response plot comparing the output of an electro-dynamic loudspeaker of FIG. 14 with a conventional single tweeter loudspeaker at 3.15 kHz.

FIG. 26 is a vertical polar response plot comparing the output of an electro-dynamic loudspeaker of FIG. 14 with a conventional single tweeter loudspeaker at 5 kHz.

FIG. 27 is a vertical polar response plot comparing the output of an electro-dynamic loudspeaker of FIG. 14 with a conventional single tweeter loudspeaker at 8 kHz.

FIG. 28 is a vertical polar response plot comparing the output of an electro-dynamic loudspeaker of FIG. 14 with a conventional single tweeter loudspeaker at 12.5 kHz.

FIG. 29 is a vertical polar response plot comparing the output of an electro-dynamic loudspeaker of FIG. 14 with a conventional single tweeter loudspeaker at 16 kHz.

FIG. 30 is a plan view of an electro-dynamic loudspeaker having a non-rectangular polygonal shape.

### DETAILED DESCRIPTION

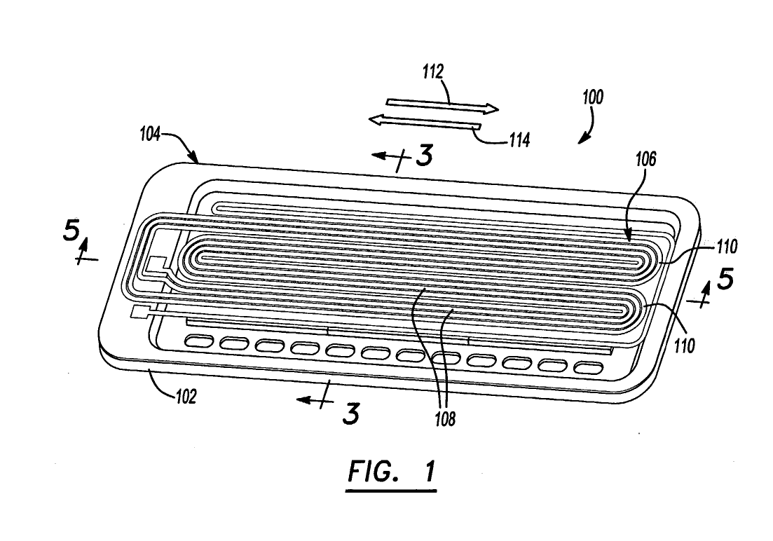

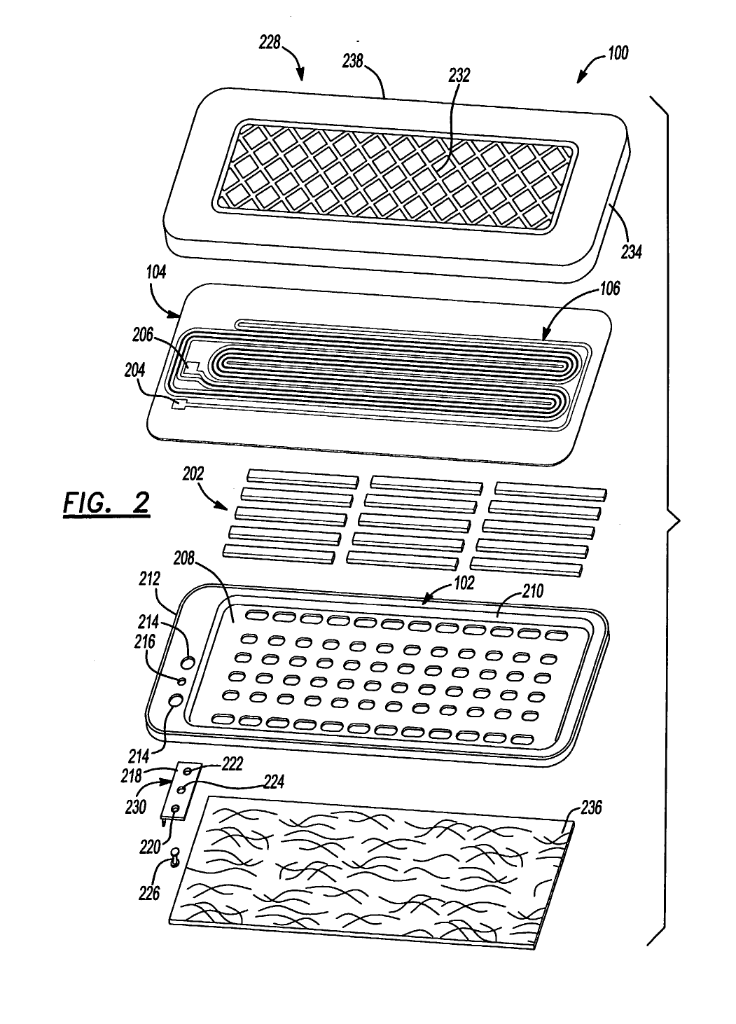

FIG. 1 is a perspective view of an electro-dynamic loudspeaker 100 of the invention. As shown in FIG. 1, the electro-dynamic loudspeaker is a generally planar loudspeaker having a frame 102 with a diaphragm 104 attached in tension to the frame 102. A conductor 106 is positioned on the diaphragm 104. The conductor 106 is shaped in serpentine fashion having a plurality of substantially linear sections (or traces) 108 longitudinally extending along the diaphragm interconnected by radii 110 to form a single current path. Permanent magnets 202 (shown in FIG. 2) are positioned on the frame 102 underneath the diaphragm 104, creating a magnetic field.

Linear sections 108 are positioned within the flux fields generated by permanent magnets 202. The linear sections 108 carry current in a first direction 112 and are positioned within magnetic flux fields having similar directional polarization. Linear sections 108 of conductor 106 having current flowing in a second direction 114, that is opposite the first direction 112, are placed within magnetic flux fields having an opposite directional polarization. Positioning the linear sections 108 in this manner assures that a driving force is generated by the interaction between the magnetic fields developed by magnets 202 and the magnetic fields developed by current flowing in conductor 106. As such, an electrical input signal traveling through the conductor 106 causes the diaphragm 104 to move, thereby producing an acoustical output.

FIG. 2 is an exploded perspective view of the electro-dynamic loudspeaker 100 shown in FIG. 1. As illustrated in FIG. 2, the flat panel loudspeaker 100 includes a frame 102, a plurality of high energy magnets 202, a diaphragm 104, an acoustical dampener 236 and a grille 228. Frame 102 provides a structure for fixing magnets 202 in a predetermined relationship to one another. In the depicted embodiment, magnets 202 are positioned to define five rows of magnets 202 with three magnets 202 in each row. The rows are arranged with alternating polarity such that fields of magnetic flux are created between each row. Once the flux fields have been defined, diaphragm 104 is fixed to frame 102 along its periphery.

A conductor 106 is coupled to the diaphragm 104. The conductor 106 is generally formed as an aluminum foil bonded to the diaphragm 104. The conductor 106 can, however, be formed from other conductive materials. The conductor 106 has a first end 204 and a second end 206 positioned adjacent to one another at one end of the diaphragm 104.

As shown in FIG. 2, frame 102 is a generally dish-shaped member preferably constructed from a substantially planar contiguous steel sheet. The frame 102 includes a base plate 208 surrounded by a wall 210. The wall 210 terminates at a radially extending flange 212. The frame 102 further includes apertures 214 and 216 extending through flange 212 to provide clearance and mounting provisions for a conductor assembly 230.

Conductor assembly 230 includes a terminal board 218, a first terminal 220 and a second terminal 222. Terminal board 218 includes a mounting aperture 224 and is preferably constructed from an electrically insulating material such as plastic, fiberglass or other insulating material. A pair of rivets or other connectors (not shown) pass through apertures 214 to electrically couple first terminal 220 to first end 204 and second terminal 222 to second end 206 of conductor 106. A fastener such as a rivet 226 extends through apertures 224 and 216 to couple conductor assembly 230 to frame 102.

A grille 228 functions to protect diaphragm 104 from contact with objects inside the listening environment while also providing a method for mounting loudspeaker 100. The grille 228 has a substantially planar body 238 having a plurality of apertures 232 extending through the central portion of the planar body 238. A rim 234 extends downward, substantially orthogonally from body 238, along its perimeter and is designed to engage the frame 102 to couple the grille 228 to the frame 102.

An acoustical dampener 236 is mounted on the underside of the base plate 208 of the frame 102. Dampener 236 serves to dissipate acoustical energy generated by diaphragm 104 thereby minimizing undesirable amplitude peaks during operation. The dampener 236 may be made of felt, or a similar gas permeable material.

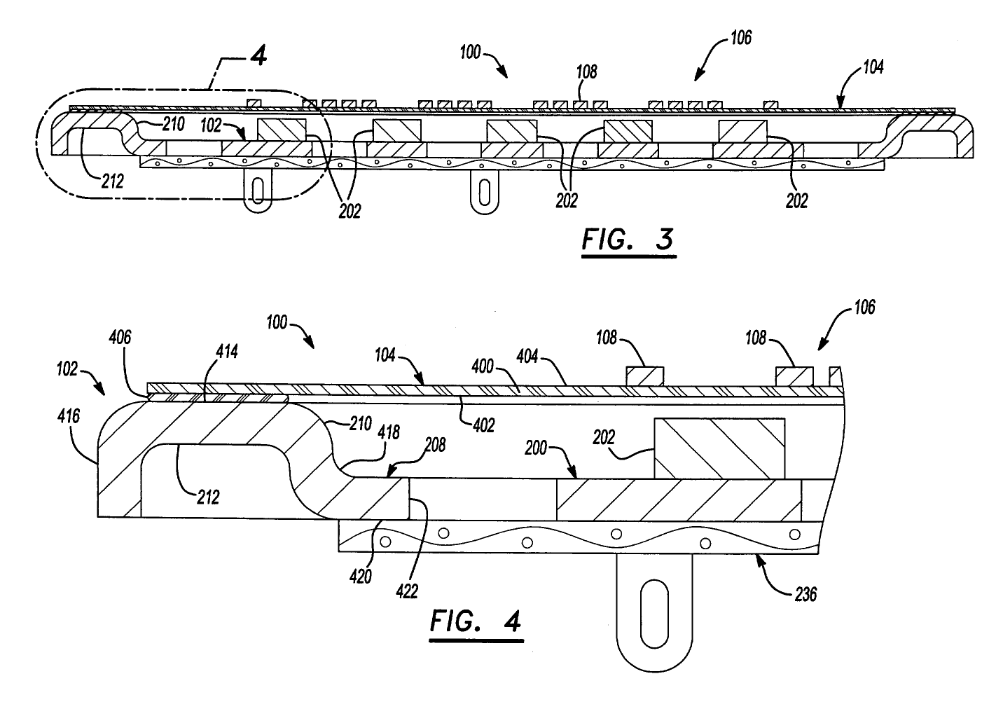

FIG. 3 is a cross-sectional view of the electro-dynamic loudspeaker taken along line 3-3 of FIG. 1. FIG. 3 shows the frame 102 having the diaphragm 104 attached in tension to the frame 102 and the permanent magnets 202 positioned on the frame 102 underneath the diaphragm 104. Linear sections 108 of the conductor 106 are also shown positioned on top of the diaphragm 104.

FIG. 4 is an enlarged cross-sectional view of the encircled area of FIG. 3. As illustrated by FIG. 4, the diaphragm 104 is comprised of a thin film 400 having a first side 402 and a second side 404. First side 402 is coupled to frame 102. Generally, the diaphragm 104 is secured to the frame 102 by an adhesive 406 that is curable by exposure to radiation. However, the diaphragm 104 may secured to the frame 102 by other mechanism, such as those known in the art.

To provide a movable membrane capable of producing sound, the diaphragm 104 is mounted to the frame 102 in a state of tension and spaced apart a predetermined distance from magnets 202. The magnitude of tension of the diaphragm 104 depends on the speaker's physical dimensions, materials used to construct the diaphragm 104 and the strength of the magnetic field generated by magnets 202. Magnets 202 are generally constructed from a highly energizable material such as neodymium iron boron (NdFeB), but may be made of other magnetic materials. The thin diaphragm film 400 is generally a polyethylenenaphthalate sheet having a thickness of approximately 0.001 inches; however, the diaphragm film 400 may be formed from materials such as polyester (e.g., known by the tradename “Mylar”), polyamide (e.g., known by the tradename “Kapton”) and polycarbonate (e.g., known by the tradename “Lexan”), and other materials known by those skilled in the art for forming diaphragms 104.

The conductor 106 is coupled to the second side 404 of the diaphragm film 400. The conductor 106 is generally formed as an aluminum foil bonded to diaphragm film 400, but may be formed of other conductive material known by those skilled in the art.

The frame 102 includes a base plate 208 surrounded by a wall 210 extending generally orthogonally upward from the plate 208. The wall 210 terminates at a radially extending flange 212 that defines a substantially planar mounting surface 414. A lip 416 extends downwardly from flange 212 in a direction substantially parallel to wall 210. Base plate 208 includes a first surface 418, a second surface 420 and a plurality of apertures 422 extending through the base plate 208. The apertures 422 are positioned and sized to provide air passageways between the first side 402 of diaphragm 104 and first surface 418 of frame 102. An acoustical dampener 236 is mounted to second surface 420 of frame base plate 208.

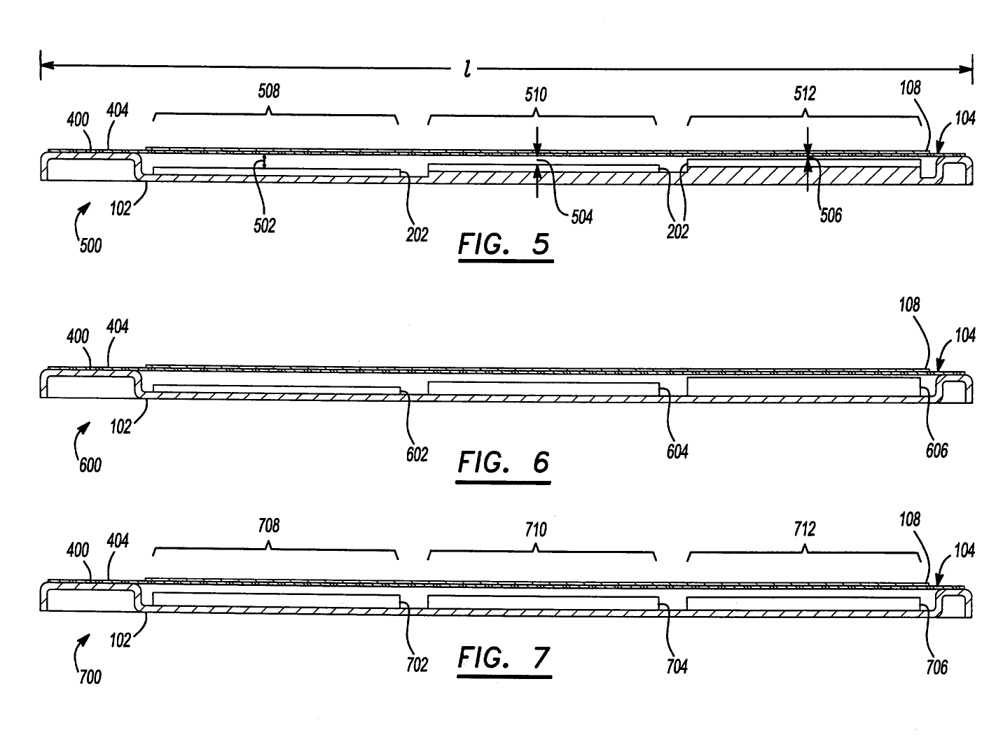

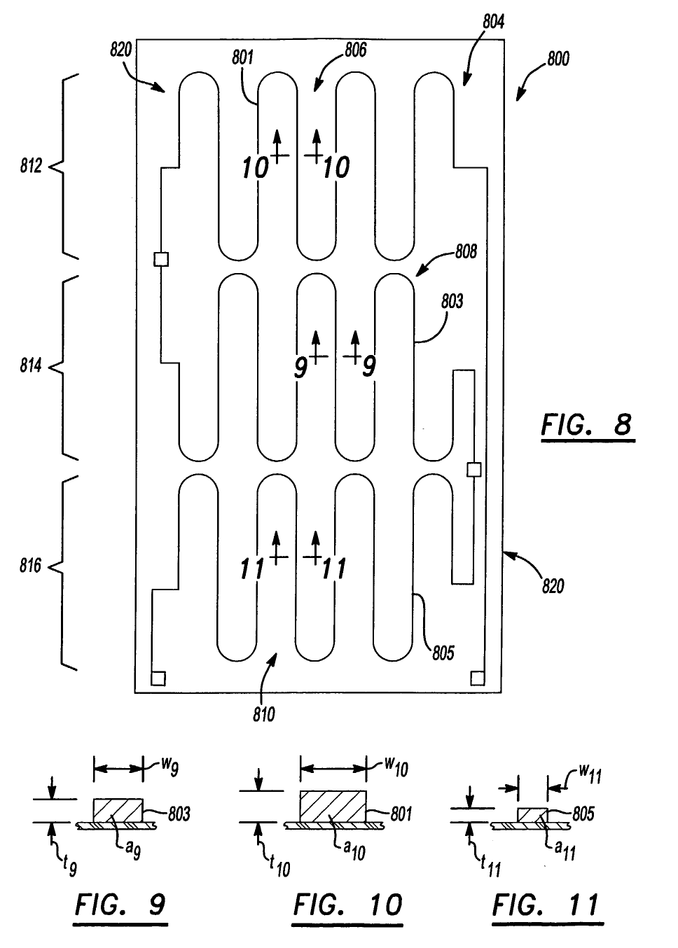

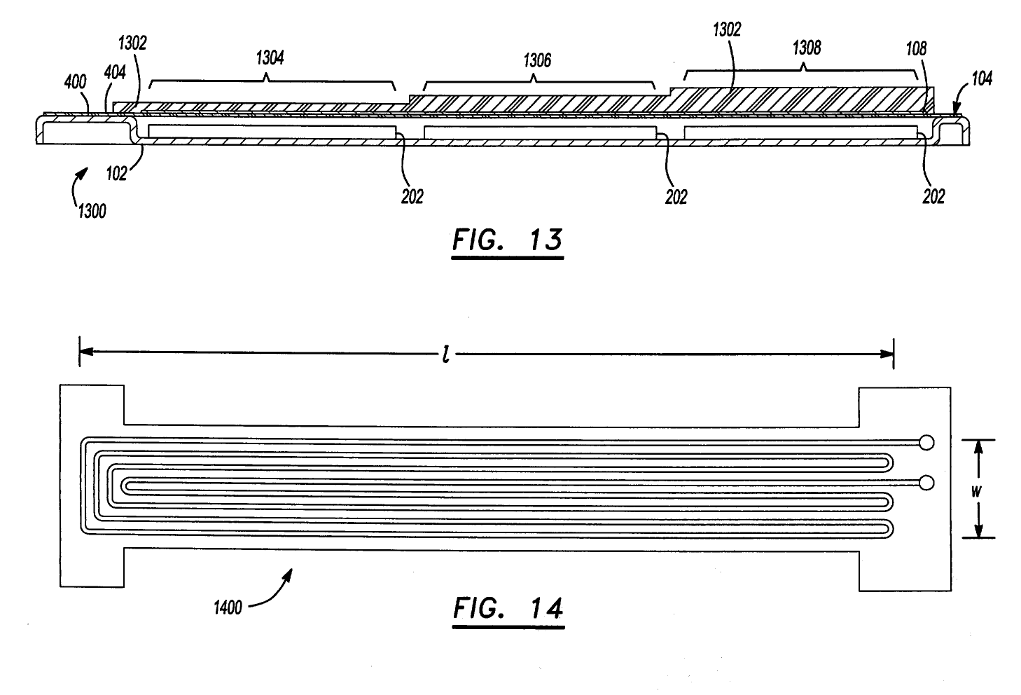

To control the acoustical directivity of the loudspeaker 100, various structural aspects of the loudspeaker 100 may be modified to produce amplitude shading of the thin film diaphragm of the loudspeaker. Amplitude shading can be accomplished by (i) varying magnetic flux density at the conductor traces (FIGS. 5-7); (ii) varying the resistance of the diaphragm traces (FIGS. 8-12); and/or (iii) varying mass over the driven portion of the diaphragm (FIG. 13). Alternatively, acoustical directivity can be controlled though varying the size of the loudspeaker, as illustrated in FIGS. 14-30.

FIGS. 5-7 illustrate various examples of amplitude shading of the thin film diaphragm of the loudspeaker by varying the magnetic flux density at the conductor traces 108. FIG. 5 is a cross-sectional view taken along the line 5-5 of FIG. 1. In FIG. 5, amplitude shading of the diaphragm 104 of the loudspeaker 500 is achieved by varying the spacing the of the magnets 202 away from the thin film diaphragm 104 at different distances 502, 504, 506 in specific and predetermined zones 508, 510, 512 of the diaphragm 104 over the length “l” of the loudspeaker 500. In this regard, the magnets 202 may be spaced from the diaphragm 104 at a distance of between about 0.1 mm to more than about 1 mm.

As shown, the magnets 202 are spaced variably closer to the diaphragm 104 across the length “L” of the loudspeaker. This arrangement may be accomplished through the structure of the frame 102 of the loudspeaker 500 that locates same sized magnets 202 at different distances 502, 504, 506 from the diaphragm 104.

Alternately, as shown in FIG. 6, is a cross-sectional view taken along the line 5-5 of FIG. 1, the frame 102 of the loudspeaker 600 may remain unchanged and magnets 602, 604, 606 having different physical dimensions may be used to vary their respective positions relative to the diaphragm 104. In either embodiment (FIG. 5 or FIG. 6), the result of the modified magnet spacing arrangement is that the flux density of the magnetic field at the location of the traces 108 (and hence the strength of the magnetic field) varies across the length “l” of the loudspeaker 500 and 600. In this regard, the flux density at the location of the traces 108 for each magnet 202 is greater as the distance between the magnet 202 and the diaphragm 104 decreases. Consequently, the sensitivity of the diaphragm 104 changes across its driven zone, resulting in amplitude shading of the diaphragm 104 and a controllable acoustical directivity of the loudspeakers 500 and 600.

FIG. 7 is a cross-sectional view, illustrating another example amplitude shading to alter the natural acoustical directivity of a loudspeaker 700 by magnetizing the plurality of magnets 702, 704, 706 in the loudspeaker 700 to different energy densities. Energy densities of magnets are measured in units of Gauss-Oersteds (GOe). For example, the magnet 702 may be magnetized to the strength of half of that of magnet 704 that, in turn, may have half of the energy density of magnet 706.

In this case the magnetic flux, measured in units called Tesla (T), that is generated by each of the different magnets 702, 704, 706 will vary across the length “1” of the loudspeaker 700 at the location of the conductive traces 108, due not to the magnets 702, 704, 706 physical spacing from the diaphragm 104, but instead to their individual magnetic strength as ultimately determined by their material compositions. This predetermined and controllable relationship between the magnets' 702, 704, 706 flux densities at the location of the conductive traces 108 over several zones 708, 710, 712 on the diaphragm 104 of the loudspeaker 700 creates amplitude shading that can produce a controlled directivity response for the loudspeaker 700.

Although the magnets of the various example embodiments of FIGS. 5-7 are define by five rows of magnets 202 with three magnets 202 in each row, the number of magnets in a row and the number of rows may vary depending upon the application. Despite the number of magnets 202 used a particular application, amplitude shading can still be accomplished to vary, control or enhance the acoustic directivity of the loudspeaker by varying the spacing between the magnets 202 and the diaphragm, by varying the size of the magnets 202 and by varying the energy densities of the magnets 202 across the diaphragm 104 of the loudspeaker 100.

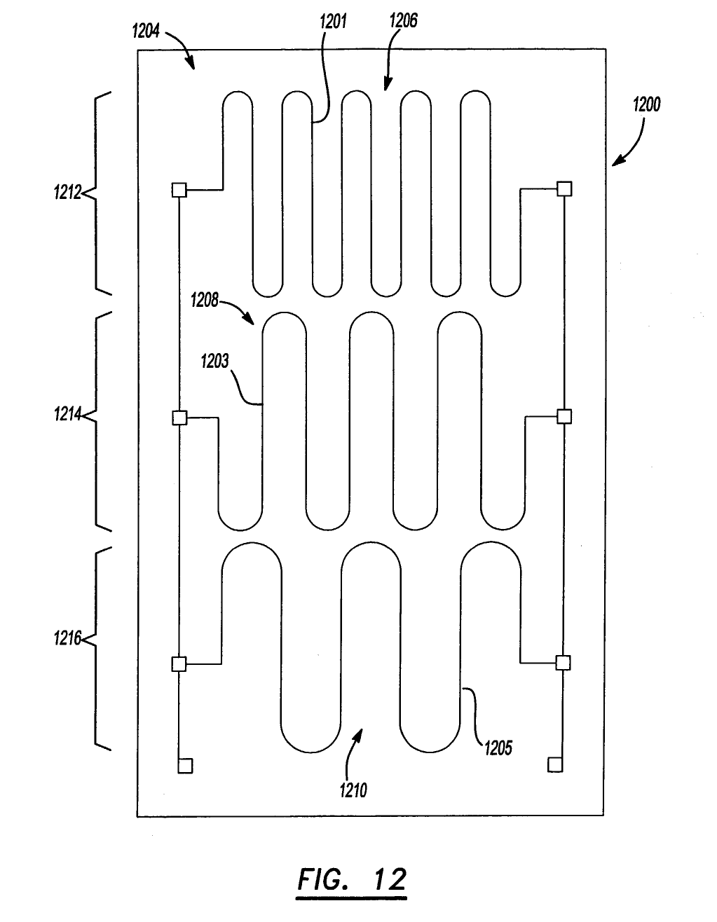

FIGS. 8-12 illustrate various examples of amplitude shading of the thin film diaphragm of the loudspeaker by varying the resistance of the conductive traces 108 of the diaphragm 104. FIG. 8 is schematic view showing a conductive trace on a diaphragm of an electro-dynamic loudspeaker 800. In FIG. 8, amplitude shading is accomplished by manipulating the dc resistance (DCR) of the plurality of traces 801, 803, 805 on the diaphragm 804 of the loudspeaker 800. For example, the diaphragm 804 may comprise a conductor 820 including a plurality of traces 801, 803, 805, respectively forming individual circuits 806, 808, 810 located in separate zones 812, 814, 816 of the diaphragm 804. In selected zones, the traces 801, 803 and 805 may be electrically in series (as shown in FIG. 8) or in parallel (see FIG. 12) to achieve the result of a different DCR in the traces 801, 803, 805 across the diaphragm 804. The variable sensitivity of the traces 801, 803, 805 affects the acoustical directivity of the loudspeaker 800 by amplitude shading of the diaphragm 804.

In addition to the relationship of the traces electrically (e.g., series or parallel), the DCR of the traces may be manipulated in other ways to achieve the same effect. For example, as shown in the cross-sections of FIGS. 9-11, the multiple traces 801, 803 and 805 on the diaphragm 804 may each possess different physical dimensions, including different widths w₉, w₁₀, w₁₁, different thicknesses t₉, t₁₀, t₁₁ (heights), and cross-sectional areas a₉, a₁₀, a₁₁.

FIG. 9 is a cross-sectional view taken along the line 9-9 of FIG. 8 showing the dimensional cross-section of the conductive trace 803 along circuit 808 of the conductor 820. FIG. 10 is a cross-sectional view taken along the line 10-10 of FIG. 8 showing the dimensional cross-section of the conductive trace 801 along circuit 806 of the conductor 820. As seen in FIG. 10, the widths w₁₀, thicknesses t₁₀ (height), and cross-sectional area a₁₀ of the conductive trace 803 in circuit 804 are larger than the widths w₉, thicknesses t₉, and cross-sectional area a₉ of the conductive trace 803 of circuit 808 (FIG. 9).

Similarly, FIG. 11 is a cross-sectional view taken along the line 11-11 of FIG. 8 showing the dimensional cross-section of the conductive trace 805 along circuit 810 of the conductor 820. As seen in FIG. 11, the widths w₁₁, thicknesses t₁₁ (height), and cross-sectional area all of the conductive trace 805 in circuit 810 are smaller than the widths w₉, thicknesses t₉, and cross-sectional area a₉ of the conductive trace 803 of circuit 808 (FIG. 9), as well as the widths w₁₀, thicknesses t₁₀ (height), and cross-sectional area a₁₀ of the conductive trace 803 in circuit 804 (FIG. 10).

FIG. 12 is a schematic view showing an alternative example of a conductive trace on a diaphragm of an electro-dynamic loudspeaker. As shown in FIG. 12, the electrical traces 1201, 1203 and 1205 are in parallel. Further, the traces of a loudspeaker 1200 may also have different lengths, resulting in their respective DCRs to be different. Similar to that described above, the loudspeaker 1200 has, for example, three traces 1201, 1203, 1205 across the diaphragm 1204. The respective traces 1201, 1203, 1205 form individual circuits 1206, 1208, 1210 connected electrically in parallel and located in separate zones 1212, 1214, 1216 of the diaphragm 1204. The lengths of the traces 1201, 1203, 1205 may, however, vary as desired.

While the example embodiment, illustrates three traces 1201, 1203 and 1205 forming three circuits 1206, 1208 and 1210, the number of traces and number of circuits formed by the traces may vary depending upon the application. Additionally, the traces 108 of the loudspeakers 100 may be formed from a number of different materials, including, but not limited to copper, aluminum alloys or other conductive materials possessing different DCR values. Such variation in physical characteristics and/or properties of a plurality of traces 108 on the diaphragm 104 enable the acoustical directivity of the loudspeaker 100 to be modified accordingly by amplitude shading.

FIG. 13 is a cross-sectional view taken along the line 5-5 of FIG. 1 showing another example of an electro-dynamic loudspeaker. In FIG. 13, amplitude shading of the diaphragm 104 of the loudspeaker 1300 may be achieved by the non-uniform application of a damping material 1302 on the second side 404 of the diaphragm 104. For example, damping material 1302 may be applied in unequal and/or excessive amounts to the surface 404, or only on selected portions of the surface 404, over the driven portion of the diaphragm 104, that may be separated into zones 1304, 1306, 1308. In this regard, damping material 1302 may be applied to a thickness that may vary from a minimum of about 0.1 mm to 3 mm or more depending upon the damping material's physical properties and/or characteristics. Such application of damping material 1302 effectively varies the mass of the diaphragm 104 across the driven zones 1304, 1306, 1308 and achieves directivity control by amplitude shading. The damping material may be made from, for example, a liquid urethane oligomer acrylic monomer blend, such as Dymax 4-20539, that cures into a flexible solid, or other material known by those skilled in the art that may be used as a dampener on thin-film diaphragms.

As illustrated by FIGS. 14-30, the acoustical directivity of an electro-dynamic loudspeaker can also be controlled by varying the size and configuration of the loudspeaker. FIG. 14 illustrates one example of a modification that can be made to the size of the loudspeaker to vary acoustical directivity.

FIG. 14 is a plan view of an electro-dynamic loudspeaker 1400 having a high aspect ratio of its length relative to its width. As illustrated by the polar response curves shown in FIGS. 15-29, by varying the length-to-width aspect ratio of the planar loudspeaker 1400, for example, by a ratio of about 10:1, the planar loudspeaker 1400 may exhibit directivity characteristics that differ greatly from a conventional loudspeaker. By way of example, the length of the loudspeaker 1400 may range from on the order of about 200 mm to about 400 mm, and the width may range from on the order of about 20 mm to about 65 mm. Such a high-aspect ratio planar loudspeaker 1400 may be particularly suitable for installation onto a structural pillar of a vehicle, such as an automobile.

The characteristic of directivity of a loudspeaker is the measure of the magnitude of the sound pressure level (SPL) of the audible output from the loudspeaker, in decibels (dB), as it varies throughout the listening environment. It is well-known that the SPL of the audible output of a loudspeaker can vary at any given location in the listening environment depending on the direction (angle) and the distance from the loudspeaker of that particular location and the frequency of the audible output from the loudspeaker. The directivity pattern of a loudspeaker may be plotted on a graph called a polar response curve. The curve is expressed in dB at an angle of incidence with the loudspeaker, where the on-axis angle is 0 degrees.

By way of example, FIG. 15 illustrates a polar response curve for a loudspeaker whose audible output is at a very low frequency relative to the size of the loudspeaker. The polar response for a loudspeaker at this low frequency is shown to be generally omni-directional. As the frequency of the audible output from a loudspeaker increases relative to the size of the loudspeaker, the polar response curve for the loudspeaker becomes increasingly directional. The increasing directivity of a loudspeaker at higher frequencies gives rise to off-axis lobes and null areas in the polar response curves, and is a phenomenon referred to as “fingering” or “lobing.”

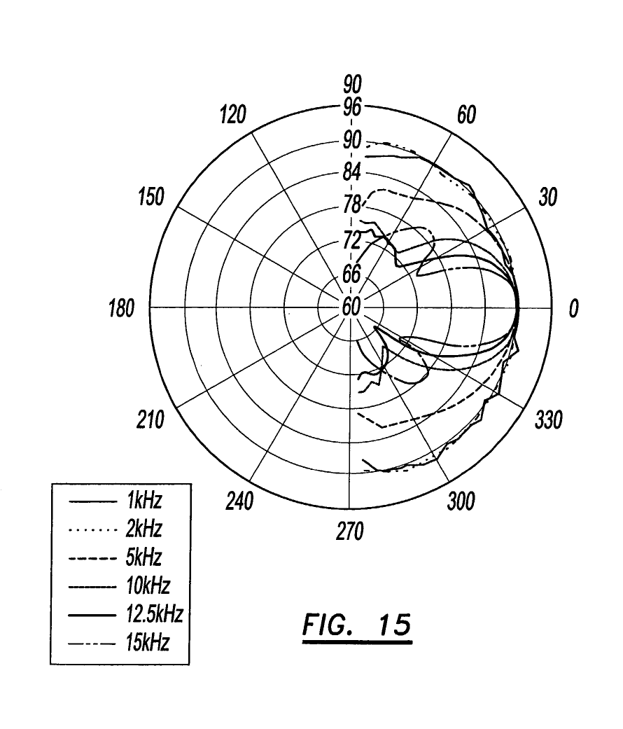

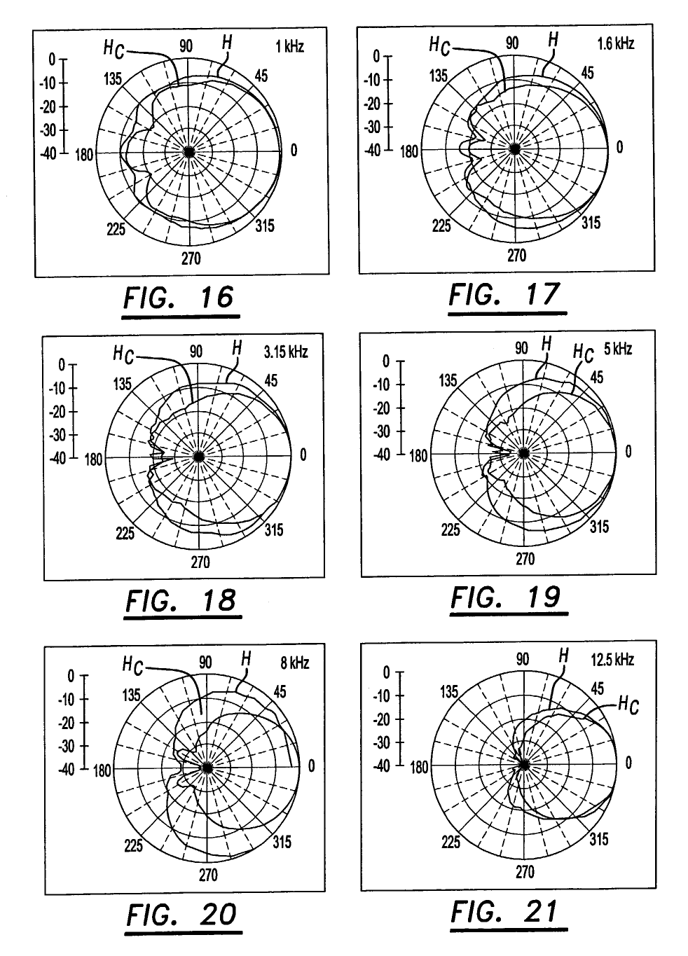

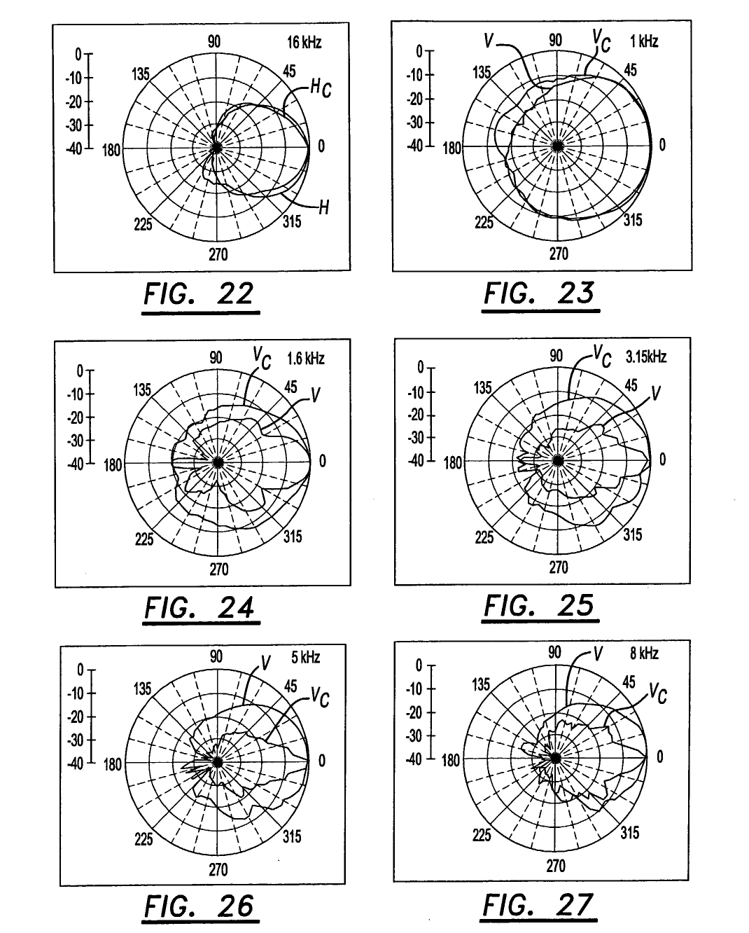

FIGS. 16-22 show the horizontal polar response plots H of a high-aspect ratio electro-dynamic loudspeaker shown in FIG. 14 at a variety of frequencies verses the horizontal polar response plots H_{c} of a conventional single tweeter loudspeaker. FIG. 16 represents the horizontal polar response plot comparison of the loudspeakers at 1 kHz. FIG. 17 is the horizontal polar response plot comparison at 1.6 kHz. FIG. 18 is the horizontal polar response comparison at 3.15 kHz. FIG. 19 is the horizontal polar response plot comparison at 5 kHz. FIG. 20 is the plot at 8 kHz, while FIGS. 21 and 22 are the plots at 12.5 kHz and 16 kHz, respectively.

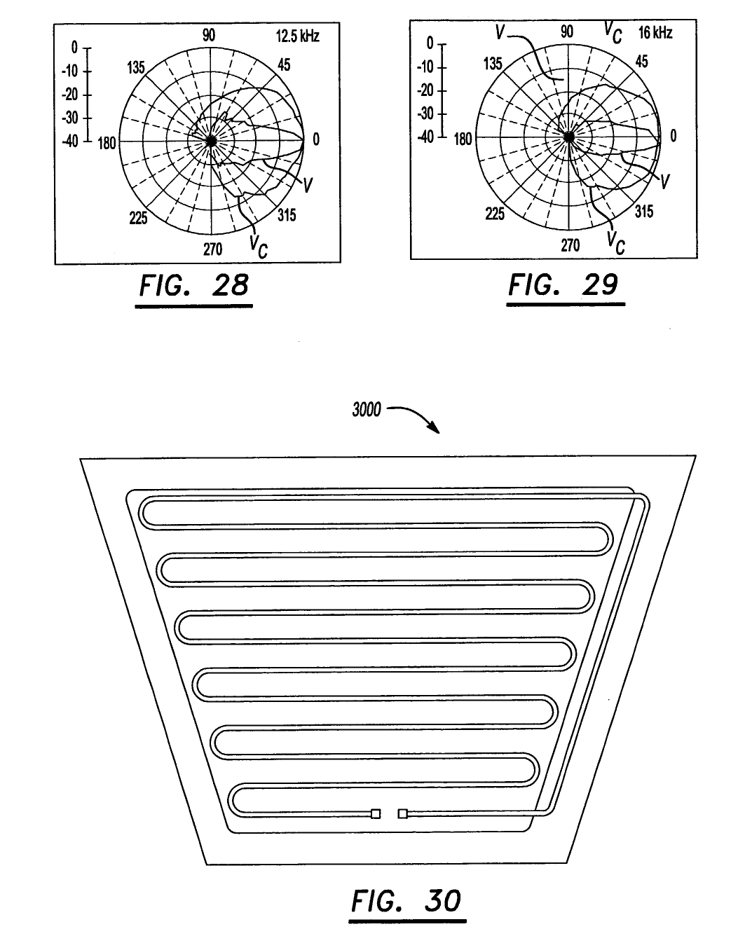

Similarly, FIGS. 23-29 depict the vertical polar response plots V of a high-aspect ratio electro-dynamic loudspeaker shown in FIG. 14 and those of a conventional single tweeter loudspeaker V_{c} at a variety of frequencies. FIG. 23 represents the vertical polar response plot of the comparing of the loudspeakers at 1 kHz. FIG. 24 is the vertical polar response plot comparison at 1.6 kHz. FIG. 25 is the vertical polar response comparison at 3.15 kHz. FIG. 26 is the vertical polar response plot comparison at 5 kHz. FIG. 27 is the plot at 8 kHz, while FIGS. 28 and 29 are the plots at 12.5 kHz and 16 kHz, respectively.

In addition to varying aspect ratio of the loudspeaker to control acoustical directivity, the shape of the loudspeaker 3000, as shown in FIG. 30, may be modified to achieve a predetermined or preferred acoustical directivity performance. FIG. 30 shows a plan view of an electro-dynamic loudspeaker 3000 having a non-rectangular polygonal shape. As illustrated by FIG. 30, the loudspeaker 3000 may take on a non-rectangular, polygonal shape, such as a trapezoid. The shaped panel reduces off-axis acoustical lobes, so that the acoustical output from the loudspeaker, particularly when amplified, provides better directional performance and control. It is contemplated that the loudspeaker may also be configured in the shape of other polygons or other non-traditional configurations to achieve the same result.

While various embodiments of the invention have been described, it will be apparent to those of ordinary skill in the art that other embodiments and implementations are possible that are within the scope of this invention. Accordingly, the invention is not restricted except in light of the attached claims and their equivalents.

What is claimed is:

1. An electro-dynamic loudspeaker comprising:
a frame;
a plurality of magnets mounted to the frame;
a diaphragm mounted to the frame; and
means for affecting the directivity of the loudspeaker by amplitude shading of the diaphragm.

2. The electro-dynamic loudspeaker of claim 1, where the means for affecting the directivity of the loudspeaker by amplitude shading of the diaphragm comprises varying the density of the magnetic flux of the magnets along the length of the diaphragm.

3. The electro-dynamic loudspeaker of claim 1 where the diaphragm has conductive traces affixed to the diaphragm and where the means for affecting the directivity of the loudspeaker by amplitude shading of the diaphragm comprises varying the DC resistance of the traces along the length of the diaphragm.

4. The electro-dynamic loudspeaker of claim 1 where the means for affecting the directivity of the loudspeaker by amplitude shading of the diaphragm comprises varying the mass of the diaphragm along the length of the diaphragm.

5. An electro-dynamic loudspeaker comprising:
a frame having a plurality of magnets mounted to the frame; and
a diaphragm mounted to the frame in a spaced relationship to each of the plurality of magnets, the plurality of magnets comprises at least one magnet mounted to the frame and spaced a first distance from the diaphragm and at least one magnet mounted to the frame and spaced a second distance from the diaphragm.

6. The electro-dynamic loudspeaker of claim 5 where the first distance is between about 0.1 mm to about 1 mm.

7. The electro-dynamic loudspeaker of claim 5 where the second distance is between about 0.2 mm to about 1.1 mm.

8. The electro-dynamic loudspeaker of claim 5 where at least one magnet is mounted to the frame and spaced a third distance from the diaphragm.

9. The electro-dynamic loudspeaker of claim 8 where the first distance is between about 0.1 mm and 1 mm, the second distance is between about 0.2 mm and 1.1 mm and the third distance is between about 0.3 mm and 1.2 mm.

10. An electro-dynamic loudspeaker comprising:
a frame;
a plurality of magnets mounted to the frame; and
a diaphragm mounted to the frame in a spaced relationship to the plurality of magnets, the plurality of magnets comprises at least one magnet generating a first magnetic flux and at least one magnet generating a second magnetic flux.

11. The electro-dynamic loudspeaker of claim 10 where the diaphragm has a plurality of conductive traces affixed to the diaphragm at a distance from the plurality of magnets and the first flux and the second flux are measured at the location of the traces.

12. The electro-dynamic loudspeaker of claim 10 where the first flux is between about 0.025 T and about 0.5 T.

13. The electro-dynamic loudspeaker of claim 10 where the second flux is between about 0.05 T and about 0.75 T.

14. The electro-dynamic loudspeaker of claim 10 further comprising at least one magnet generating a third flux.

15. The electro-dynamic loudspeaker of claim 14 where the first flux is between about 0.025 T and about 0.5 T, the second flux is between about 0.05 T and about 0.75 T, and the third flux is between about 0.075 T and about 1 T.

16. The electro-dynamic loudspeaker of claim 10 where at least one of the plurality of magnets is energized to a first energy density and at least one of the plurality of magnets is energized to a second energy density.

17. The electro-dynamic loudspeaker of claim 16 where the first energy density is between about 20 MGOe and about 40 MGOe.

18. The electro-dynamic loudspeaker of claim 16 where the second energy density is between about 25 MGOe and about 45 MGOe.

19. The electro-dynamic loudspeaker of claim 16 where at least one of the plurality of magnets is energized to a third energy density.

20. The electro-dynamic loudspeaker of claim 19 where the first energy density is between about 20 MGOe and about 40 MGOe, the second energy density is between about 25 MGOe and about 45 MGOe, and the third energy density is between about 30 MGOe and about 50 MGOe.

21. An electro-dynamic loudspeaker comprising:
a frame;
a plurality of magnets mounted to the frame;
a diaphragm mounted to the frame, the diaphragm comprising a thin film having a conductor affixed to the film, the conductor comprises a plurality of electrical circuits.

22. The electro-dynamic loudspeaker of claim 21 where the plurality of circuits are electrically connected in series.

23. The electro-dynamic loudspeaker of claim 21 where the plurality of circuits are electrically connected in parallel.

24. The electro-dynamic loudspeaker of claim 21 where:
the diaphragm has a driven portion; and
the plurality of circuits are located in the separate zones of the driven portion.

25. The electro-dynamic loudspeaker of claim 21 where the plurality of circuits conductive traces, and the traces for at least two of the plurality of circuits have different cross-sectional areas.

26. The electro-dynamic loudspeaker of claim 21 where the plurality of circuits each comprise conductive traces and the traces for at least two of the plurality of circuits are comprised of different materials.

27. The electro-dynamic loudspeaker of claim 21 where the plurality of circuits are each comprised of conductive traces and the combined length of the traces for at least two of the plurality of circuits are different.

28. An electro-dynamic loudspeaker comprising:
a frame;
a plurality of magnets mounted to the frame;
a diaphragm mounted to the frame, the diaphragm having a driven portion; and
a damping material layered on the diaphragm over at least part of the driven portion.

29. The electro-dynamic loudspeaker of claim 28 where the damping material is layered on the diaphragm to a thickness of about 0.1 mm to about 3 mm.

30. The electro-dynamic loudspeaker of claim 28 where the damping material is layered on the diaphragm to a first thickness in a first zone of the driven portion and to a second thickness in a second zone of the driven portion.

31. The electro-dynamic loudspeaker of claim 30 where the damping material is layered on the diaphragm to a thickness of about 0.1 mm in the first zone and to a thickness of about 3 mm in the second zone.

32. An electro-dynamic loudspeaker comprising:
a frame;
a plurality of magnets mounted to the frame;
a diaphragm mounted to the frame, the diaphragm having a length and a width, where the ratio of the length to the width is about 10:1.

33. The electro-dynamic loudspeaker of claim 30 where the length of the diaphragm is about 200 mm and about 400 mm and the width of the diaphragm is about 20 mm to about 65 mm.

34. An electro-dynamic loudspeaker comprising:
a polygonal-shaped frame, the frame having at least two pairs of sides that intersect at an angle the value of which is greater than ninety degrees;
a plurality of magnets mounted to the frame; and
a diaphragm mounted to the frame.
